(19) United States
(12) Patent Application Publication
(10) Pub. No.: US 2011/0185009 A1
(43) Pub. Date: Jul. 28, 2011

(54) RESOURCE SHARING DEVICES

(75) Inventors: Ming-Te Chang, LuChou (TW); Chung-Yi Lin, Xinfeng Township (TW)

(73) Assignee: OURS TECHNOLOGY INC., Jubei (TW)

(21) Appl. No.: 12/692,011

(22) Filed: Jan. 22, 2010

(51) Int. Cl. G06F 15/16

(52) U.S. Cl. 709/203

(57) ABSTRACT

The present invention is related to a resource sharing device in a communication system including multiple computing devices. The resource sharing device includes a first interface to couple with a first computing device, a second interface to couple with a second computing device, a function device to provide a function accessible to the first and second computing devices, and a switch device coupled with the function device, the switch device to generate a device descriptor of the function device so that when the first and second computing devices are coupled with the resource sharing device the device descriptor of the function device is sent to the first and second computing devices so as to share the function of the function device to the first and second computing devices and allow the first and second computing devices to be controllable at a time by the function of the function device.

### TECHNICAL FIELD

The present invention relates generally to an interface device and, more particularly, to a resource sharing device of which the data, resource and function are accessible to at least one computing device.

### BACKGROUND

Computing devices, for example, personal computers, laptops and smart phones, are widely used in everyday life and may operate in conjunction with peripheral devices such as media players, universal serial bus (USB) drivers or portable hard disks. To couple with a computing device, a peripheral device may be connected in a wired or wireless fashion through a communication port built in or local to the computing device. Data communications between the computing device and the peripheral device may be made with the help of protocols related to the communication port. Such data communications between a computing device and a peripheral device may not be useful in the case of two computing devices when directly coupled together because both of the computing devices may contend with each other for the role of a master device during communications. Consequently, communications therebetween may not be established, which in turn may incur system failure, abnormal end of task or malfunction of the computing devices. Accordingly, switch devices such as keyboard/video/mouse (KVM) switches have been developed.

FIG. 1 is a diagram of a communication system 10 in prior art using a KVM switch 13. Referring to FIG. 1, the KVM switch 13, either a hardware or software switch, may allow a user to use one of a first computing device 11 and a second computing device 12 through human interface devices (HIDs) including, for example, a keyboard 14, a mouse 15 and a monitor 16. Specifically, the user may be allowed to use the first computing device 11 when the KVM switch 13 is coupled thereto, and may then be allowed to use the second computing device 12 when the KVM switch 13 switches its connection to the second computing device 12. Although two or more computing devices are coupled to the KVM switch 13, generally only one computing device may be controlled at a time.

With the increasing interest in compact, low-profile and light-weight electronic products, some computing devices may be designed with an economic number of embedded function devices or modules. For example, some computing devices may not include embedded storage media such as a CD-ROM (i.e., a CD-R or CD-RW) or a DVD-ROM (i.e., a DVD-R or DVD-R/W). Moreover, some may only provide essential storage capability (e.g., a small hard disk) which may support certain applications where large storage is required. When using such computing devices, users may not have enough functions or storage to use. The KVM switch 13 does not provide such resource to the associated commuting devices except, for example, the switching function.

It may therefore be desirable to have a resource sharing device that allows at least one computing device to access the data, resource or function of the resource sharing device.

### BRIEF SUMMARY

Examples of the present invention may provide a resource sharing device in a communication system including multiple computing devices. The resource sharing device includes a first interface to couple with a first computing device, a second interface to couple with a second computing device, a function device to provide a function accessible to the first and second computing devices, and a switch device coupled with the function device, the switch device to generate a device descriptor of the function device so that when the first and second computing devices are coupled with the resource sharing device the device descriptor of the function device is sent to the first and second computing devices so as to share the function of the function device to the first and second computing devices and allow the first and second computing devices to be controllable at a time by the function of the function device.

Some examples of the present invention may also provide a resource sharing device in a communication system including multiple computing devices. The resource sharing device includes a first interface to couple with a first computing device, a second interface to couple with a second computing device, a human interface device (HID) accessible to the first and second computing devices, and a switch device coupled with the HID, the switch device including a memory to store a first set of codes associated with the HID, and a micro processor to generate a device descriptor of the HID by executing the first set of codes, wherein the switch device is configured to send the device descriptor of the HID to the first computing device when the first computing device is coupled with the resource sharing device, allowing the first computing device to access the HID, and send the device descriptor of the HID to the second computing device when the second computing device is coupled with the resource sharing device, allowing the second computing device to access the HID, and allowing the first and second computing devices to be controllable at a time by the HID.

Examples of the present invention may provide a resource sharing device in a communication system including multiple computing devices. The resource sharing device includes a first interface to couple with a first computing device, a second interface to couple with a second computing device, a function module including resources and data accessible to the first and second computing devices, and a switch device coupled with the function device, the switch device including a memory to store a first set of codes associated with the function module, and a micro processor to generate a device descriptor of the function module by executing the first set of codes, wherein the switch device is configured to send the device descriptor of the function module to the first and second computing devices when the first and second computing devices are coupled with the resource sharing device, allowing the first and second computing devices to access the function module at the same time.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a diagram of a communication system in prior art using a keyboard/video/mouse (KVM) switch;

FIG. 2A is a diagram of a communication system in accordance with an example of the present invention;

FIG. 2B is a diagram of a first and a second computing devices in the communication system illustrated in FIG. 2A;

FIG. 2C is a schematic block diagram of the communication system illustrated in FIGS. 2A and 2B;

FIG. 2D is a schematic diagram illustrating an application of an exemplary resource sharing device;

FIG. 2E is a schematic diagram illustrating an application of another exemplary resource sharing device;

FIG. 3 is a diagram illustrating an exemplary device descriptor;

FIG. 4 is a flow diagram illustrating a method of operating a resource sharing device including a human interface device (HID) in accordance with an example of the present invention;

FIG. 5 is a flow diagram illustrating a method of operating a resource sharing device including a function module in accordance with an example of the present invention;

FIG. 6 is a flow diagram illustrating a method of resource transfer from one computing device to another by using a resource sharing device in accordance with an example of the present invention; and

FIG. 7 is a flow diagram illustrating a method of data transfer between computing devices by using a resource sharing device in accordance with an example of the present invention.

### DETAILED DESCRIPTION

Reference will now be made in detail to the present examples of the invention, examples of which are illustrated in the accompanying drawings. Wherever possible, the same reference numbers will be used throughout the drawings to refer to the same or like parts.

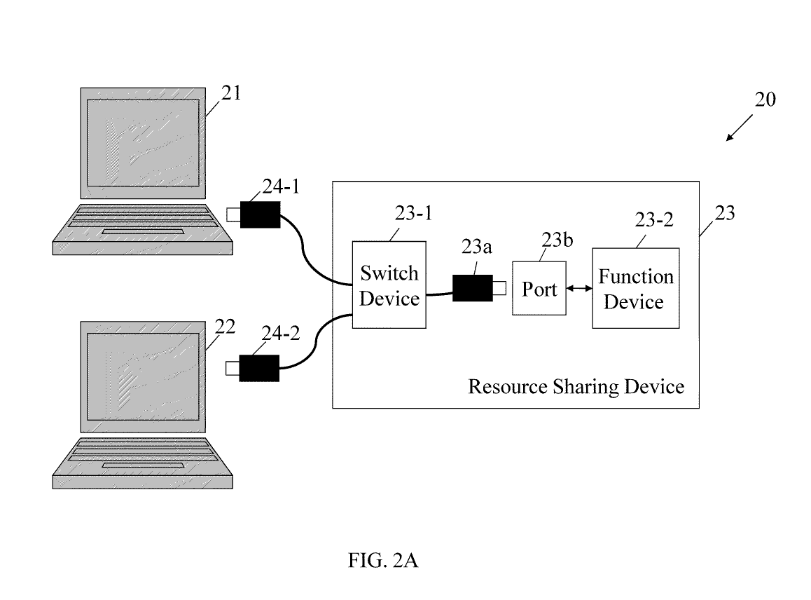

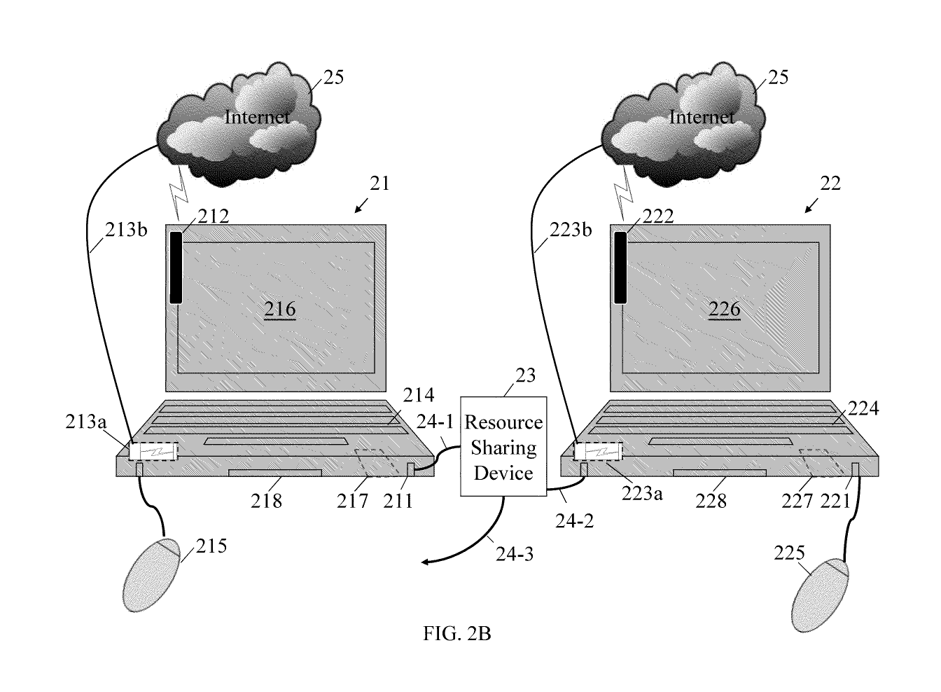

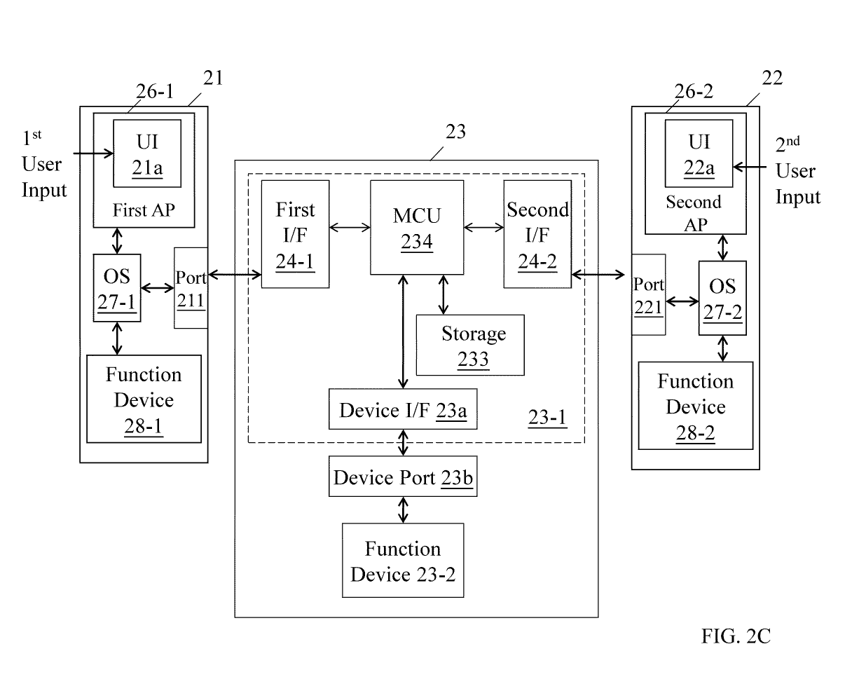

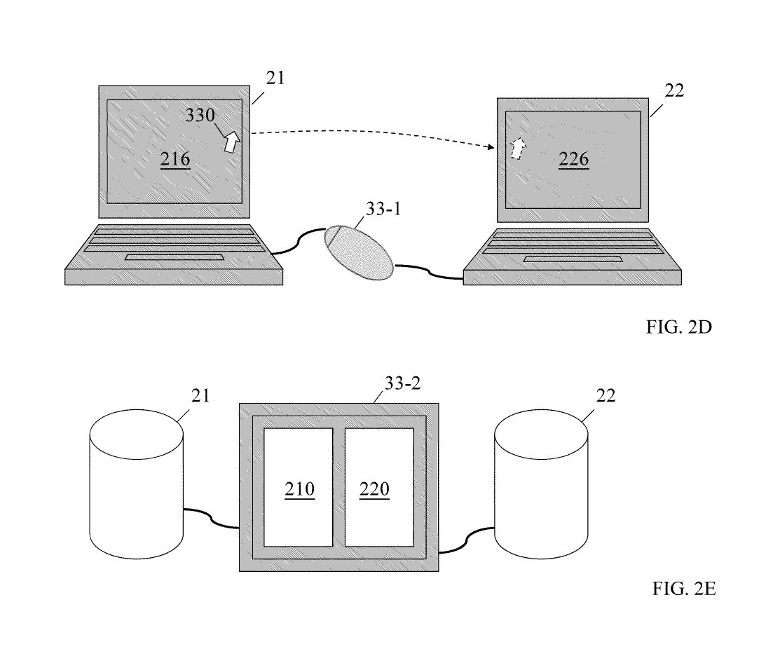

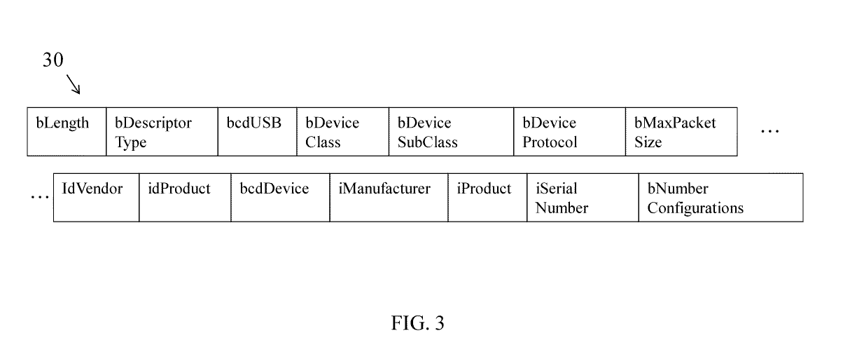

FIG. 2A is a diagram of a communication system 20 in accordance with an example of the present invention. Referring to FIG. 2A, the communication system 20 may include a first computing device 21, a second computing device 22 and a resource sharing device 23. The first computing device 21 and the second computing device 22 may each include one of a server, a main frame, a personal computer, a laptop computer, a notebook computer and a smart phone. Moreover, the resource sharing device 23 may include a switch device 23-1 and a function device 23-2. The switch device 23-1 may be coupled with the first computing device 21 and second computing device 22 via a first interface 24-1 and a second interface 24-2, respectively, either in a wired or wireless manner. Furthermore, the switch device 23-1 may be coupled to the function device 23-2 by coupling a device interface 23a of the switch 23-1 to a device port 23b of the function device 23-2.

In one example according to the present invention, the function device 23-2 may include a human interface device (HID) such as a keyboard, monitor or mouse. In another example, the function device 23-2 may include a function module such as a USB hard drive, a USB CD-ROM (i.e., a CD-R or CD-RW) or DVD-ROM (i.e., a DVD-R or DVD-R/W), a TV tuner or a DVB-T tuner, a printer, and a physical embedded device including one of a network interface module or card (NIC), an embedded CD-ROM and a storage device including a hard disk or memory. In implementation, in one example, the resource sharing device 23 may take the form of the HID or function module 23-2 with the switch device 23-1 integrated therewith or incorporated therein. For example, the resource sharing device 23 may include a mouse with a switch device therein.

FIG. 2B is a diagram of the first and second computing devices 21 and 22 in the communication system 20 illustrated in FIG. 2A. Referring to FIG. 2B, the first computing device 21 may include one or more first function device including HIDs such as a keyboard 214, a mouse 215 and a monitor 216, function modules such as a USB hard drive, a USB CD-ROM or DVD-ROM attachable to a first port 211, physical embedded devices and pseudo devices. Examples of the physical embedded devices may include a network interface module or card (NIC) 213a to link to the Internet 25 via a cable 213b, an antenna 212, a storage device 217 such as a hard disk or a memory, an embedded CD-ROM or DVD-ROM 218, and a TV tuner or a DVB-T tuner (not shown). Moreover, examples of pseudo devices may include a virtual machine, which may take the form of software capable of executing an image file including data structure in CD or DVD format, such as a CD image file or a DVD image file.

Similarly, the second computing device 22 may include one or more second function device including HIDs such as a keyboard 224, a mouse 225 and a monitor 226, function modules such as a USB hard drive, a USB CD-ROM or DVD-ROM attachable to a second port 221, physical embedded devices and pseudo devices. The physical embedded devices may include a network interface module or card (NIC) 223a to link to the Internet 25 via a cable 223b, an antenna 222, a storage device 227 such as a hard disk or a memory, an embedded CD-ROM or DVD-ROM 228, and a TV tuner or a DVB-T tuner (not shown).

In the present example, the resource sharing device 23 may be coupled between the first and second computing devices 21 and 22. In other examples, however, the resource sharing device 23, which further includes one or more third interface 24-3, may be coupled among three of more computing devices.

FIG. 2C is a schematic block diagram of the communication system 20 illustrated in FIGS. 2A and 2B. Referring to FIG. 2C, the first computing device 21 may be provided with a first application (AP) module 26-1, which may include programming codes or software, a first operating system (OS) 27-1 and one or more first function device 28-1, which may be controlled or controllable by the first OS 27-1.

Similarly, the second computing device 22 may be provided with a second application (AP) module 26-2, a second operating system (OS) 27-2 and one or more function device 28-2, which may be controlled or controllable by the second OS 28-2.

The switch device 23-1 of the resource sharing device 23 may include the first interface 24-1 to couple with the first port 211 of the first computing device 21, the second interface 24-2 to couple with the second port 221 of the second computing device 22, the device interface 23a to couple with the function device 23-2 via the device port 23b, a storage device 233 such as a random access memory (RAM), and a micro control unit (MCU) 234 such as a micro processor to control communication and data flow within the resource sharing device 23. Examples of the ports 211, 221 and 23b may include one or more of a universal serial bus (USB) port (either A-type or B-type), an IEEE1394 port, a Bluetooth port, an IrDA port, an Ethernet port, an SPI port, an I²C port, a GPIO port, a PCI port, a PCI Express port or a serial advanced technology attachment (Serial ATA or SATA) port. Moreover, the interfaces 24-1, 24-2 and 23a may include a USB port connector (either for A-type or B-type USB port), an IEEE1394 port connector, an Ethernet connector, an SPI connector, an I²C connector, a GPIO connector, a PCI connector, a PCI Express port connector or a SATA port connector (no physical connectors if it corresponds to the Bluetooth port or the IrDA port). Accordingly, each of the first, second and device interfaces 24-1, 24-2 and 23a may be able to support data transfer in one of, for example, a universal serial bus (USB) (either A-type or B-type), IEEE1394, Bluetooth, IrDA, Ethernet, SPI, I²C, a GPIO, PCI, PCI Express and serial advanced technology attachment (Serial ATA or SATA) protocols. Moreover, the protocol type of the first interface 24-1 is supported by the first computing device 21, the protocol type of the second interface 24-2 is supported by the second computing device 22 and the protocol type of the device interface 23a is supported by the function device 23-2.

In one example, at least one of the first and second AP modules 26-1 and 26-2 may be installed by a user of the communication system 20. In other examples, the storage device 233 may store a set of codes, which may include programming codes or firmware executable by the MCU 234, and at least one of the first and second APs 26-1 and 26-2 may be respectively set up in the first and second computing devices 21 and 22 by automatically running the set of codes in the MCU 234 when the first or second computing device 21 or 22 is coupled. Alternatively, at least one of the first and second AP modules 26-1 and 26-2 may be implemented in hardware, which may be fabricated in an integrated chip (IC).

The MCU 234 may generate device information on the function device 23-2 so that when the first computing device 21 is coupled, the resource sharing device 23 may provide the device information to the first computing device 21, which may then use the resource of the function device 23-2. Likewise, the resource sharing device 23 may provide the device information to the second computing device 22 when coupled, which may allow the second computing device 22 to use the resource of the function device 23-2.

In operation, in the example that the function device 23-2 includes an HID, for example, a mouse, the MCU 234 may generate device information such as a device descriptor of the mouse, and send the device descriptor to the first computing device 21 so that the resource sharing device 23 may serve as a mouse for the first computing device 21. When at a later time the second computing device 22 is coupled to the resource sharing device 22, the MCU 234 may send the device descriptor to the second computing device 22. The second computing device 22 may not have the “token”, i.e., the authority to use the resource sharing device 23 as a mouse, unless there is a control signal allowing the second computing device 22 to take the token. The control signal in one example may be initiated by the user by clicking a button (not shown) on the resource sharing device 23, which may command the first computing device 21 to transfer the token to the second computing device 22. In another example, the first computing device 21 may monitor the cursor or screen coordinate and the first AP module 26-1 may generate the control signal when the mouse moves beyond the coordinate margin.

In the case that the function device 23-2 includes a keyboard, similar to the case of mouse, the control signal may be initiated by the user or generated by the first AP module 26-1 when the cursor coordinate margin or screen coordinate margin is reached.

In the case that the function device 23-2 includes a video monitor, the control signal may be initiated by the user, or generated by the first AP module 26-1 when a predetermined key or a predetermined combination of keys on the keyboard are entered. For example, the second computing device 22 may take the token when the keys “Ctrl”, “Alt” and “F12” are entered.

Moreover, in the example that the function device 23-2 includes a function module, for example, a CD-ROM, the MCU 234 may generate device information such as a device descriptor of the CD-ROM, and send the device descriptor to the first computing device 21 so that the resource sharing device 23 may serve as a CD-ROM for the first computing device 21. When at a later time the second computing device 22 is coupled to the resource sharing device 22, the MCU 234 may send the device descriptor to the second computing device 22, which allows the second computing device 22 to use the resource sharing device 23 as a CD-ROM. In the case that the function device 23-2 includes a function module such as a CD-ROM, DVD-ROM or hard disc, the first and second computing devices 21 and 22 may use the resource simultaneously without competing for the token.

In addition to allowing its resource to be accessible to the first and second computing devices 21 and 22, the resource sharing device 23 may be configured to support resource transfer and data transfer between the first and second computing devices 21 and 22 as well. The first AP module 26-1 may further include a first user interface (UI) 21a, which may provide at least one item, either a textual label or a graphical icon, selectable by a user. Each of the at least one item may be related to one of the at least one first function device 28-1. The first UI 21a may be configured to receive a user input from the user selecting one of the at least one item and in turn one of the at least one first function device 28-1 related to the selected item. The first AP module 26-1 may generate a set of codes in response to the one item selected by the user and load the codes into the storage device 233 of the resource sharing device 23 via the first interface 24-1. The set of codes may include programming codes or firmware executable by the MCU 234.

In operation, the set of codes may be retrieved from the storage device 233 and executed by the MCU 234 for generating device information on the selected one of the first function device 28-1, which may facilitate the second computing device 22 to identify the selected function device. Based on the set of codes, the device information may be generated in a format consistent with the protocol type of the second interface 24-2 and include parameters related to the selected one of the first function device 28-1. The device information may include but is not limited to, for example, at least one of the type, resource, operating frequency, size and/or status of storage, packet format or power consumption of the selected one of the first function device 28-1.

When the device information is sent to the second computing device 22, the first AP module 26-1 may initiate a negotiation process for setting up communications between the first computing device 21 and the second communication device 22 via the resource sharing device 23. Since the device information received by the second computing device 22 is related to the selected function device, the second computing device 22 may emulate the first computing device 21 and the resource sharing device 23 as a whole as the selected function device. The second computing device 22 may then transmit or receive packets based on the protocol in a type, packet format or size described in the device information. Hence, the second computing device 22 is capable of using the resource or function of the selected one of the first function device 28-1.

Similarly, the second AP module 26-2 may further include a second user interface (UI) 22a, which may provide at least one item, either a textual label or a graphical icon, selectable by a user. Each of the at least one item may be related to one of the at least one second function device 28-2. The second UI 22a may be configured to receive a user input from the user selecting one of the at least one item and in turn one of the at least one second function device 28-2 related to the selected item. The second AP module 26-2 may generate a set of codes in response to the one item selected by the user and load the codes into the storage device 233 of the resource sharing device 23 via the second interface 24-2. The set of codes may include programming codes or firmware executable by the MCU 234.

In operation, the set of codes may be retrieved from the storage device 233 and executed by the MCU 234 for generating device information on the selected one of the second function device 28-2, which may facilitate the first computing device 21 to identify the selected function device. Based on the set of codes, the device information may be generated in a format consistent with the protocol type of the first interface 24-1 and include parameters related to the selected one of the second function device 28-2. The device information may include but is not limited to, for example, at least one of the type, resource, operating frequency, size and/or status of storage, packet format or power consumption of the selected one of the second function device 28-2.

When the device information is sent to the first computing device 21, the second AP module 26-2 may initiate a negotiation process for setting up communications between the first computing device 21 and the second communication device 22 via the resource sharing device 23. Since the device information received by the first computing device 21 is related to the selected function device, the first computing device 21 may emulate the second computing device 22 and the resource sharing device 23 as a whole as the selected function device. The first computing device 21 may then transmit or receive packets based on the protocol in a type, packet format or size described in the device information. Hence, the first computing device 21 is capable of using the resource or function of the selected one of the second function device 28-2.

More examples of resource transfer between computing devices may be found in co-pending U.S. patent application Ser. No. 12/505,706, filed Jul. 20, 2009 by the same assignee.

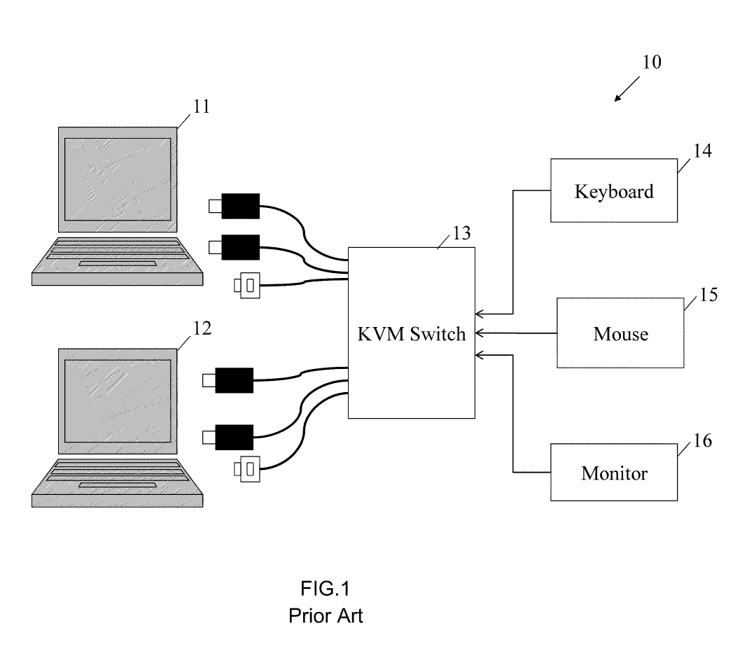

FIG. 2D is a schematic diagram illustrating an application of an exemplary resource sharing device 33-1. The resource sharing device 33-1 may be similar to the resource sharing device 23 described and illustrated with reference to FIGS. 2A to 2C. In the present example, referring to FIG. 2D, the sharing device 33-1 may include a mouse incorporated with the switch device 23-1. The resource or function of the resource sharing device 33-1, i.e., a mouse, may be shared to the first and second computing devices 21 and 22 when they are coupled with the resource sharing device 33-1. In operation, the movement of a cursor 330 associated with the resource sharing device 33-1 may be detected by the first and second AP modules 26-1 and 26-2. Accordingly, when the cursor 330 moves out of the coordinate margin of the first monitor 216 toward the second monitor 226, the second computing device 22 may be allowed to use the function of the mouse. Likewise, when the cursor 330 moves out of the coordinate margin of the second monitor 226 toward the first monitor 216, the first computing device 21 may be allowed to use the function of the mouse. Either way, the resource sharing device 33-1 may allow the first and second computing devices 21 and 22 to be controllable at a time by a user of the resource sharing device 33-1, unlike the KVM switch 13 illustrated in FIG. 1, where only one computing device may be controllable at a time by a user.

In other examples, the resource sharing device 33-1 may be coupled with three or more computing devices. The resource sharing device 33-1 may share its function to the multiple computing devices and allow the multiple computing devices to be controllable at a time by the function.

FIG. 2E is a schematic diagram illustrating an application of another exemplary resource sharing device 33-2. The resource sharing device 33-2 may be similar to the resource sharing device 23 described and illustrated with reference to FIGS. 2A to 2C. In the present example, referring to FIG. 2E, the sharing device 33-2 may include a video display incorporated with the switch device 23-1. The resource or function of the resource sharing device 33-2, i.e., a video display, may be shared to the first and second computing devices 21 and 22 when they are coupled with the resource sharing device 33-2. In operation, a first portion 210 of the video display may be used to display a first image from first computing device 21 and a second portion 220 of the video display may be used to display a second image from the second computing device 22 at the same time with the first image. Accordingly, the resource sharing device 33-2 may allow the first and second computing devices 21 and 22 to be controllable at a time by a user of the resource sharing device 33-2.

FIG. 3 is a diagram illustrating an exemplary USB device descriptor 30 for the communication system 20 described and/or illustrated with reference to FIGS. 2A to 2C. Referring to FIG. 3, the device descriptor 30 may specify information on one of the function devices 28-1, 28-2 and 23-2 including, for example, the supported protocol, maximum packet size, vendor and product IDs and the number of possible configurations available for the selected function device.

In one example, the format of the device descriptor 30 may be one as shown in the following table:

| Offset | Field | Size | Value | Description |
|---|---|---|---|---|
| 0 | bLength | 1 | Number | Size of the Descriptor |
| | | | | in Bytes (18 bytes) |
| 1 | bDescriptorType | 1 | Constant | Device Descriptor (0x01) |
| 2 | bcdUSB | 2 | BCD | USB Specification Number |
| | | | | which device complies too. |
| 4 | bDeviceClass | 1 | Class | Class Code (Assigned |
| | | | | by USB Org) |
| | | | | If equal to Zero, |
| | | | | each interface specifies it |
| | | | | □ own class code |
| | | | | If equal to 0xFF, the |
| | | | | class code is vendor |
| | | | | specified. Otherwise field is |
| | | | | valid Class Code. |
| 5 | bDeviceSubClass | 1 | SubClass | Subclass Code (Assigned |
| | | | | by USB Org) |
| 6 | bDeviceProtocol | 1 | Protocol | Protocol Code (Assigned |
| | | | | by USB Org) |
| 7 | bMaxPacketSize | 1 | Number | Maximum Packet Size |
| | | | | for Zero Endpoint. |
| | | | | Valid Sizes are 8, 16, 32, 64 |
| 8 | idVendor | 2 | ID | Vendor ID (Assigned |
| | | | | by USB Org) |
| 10 | idProduct | 2 | ID | Product ID (Assigned |
| | | | | by Manufacturer) |
| 12 | bcdDevice | 2 | BCD | Device Release Number |
| 14 | iManufacturer | 1 | Index | Index of Manufacturer |
| | | | | String Descriptor |
| 15 | iProduct | 1 | Index | Index of Product String |
| | | | | Descriptor |
| 16 | iSerialNumber | 1 | Index | Index of Serial Number |
| | | | | String Descriptor |
| 17 | bNumConfigurations | 1 | Integer | Number of Possible |
| | | | | Configurations |

Referring to the table, also referring to FIG. 3, the USB device descriptor may include entries in the “Field” column of different bit sizes and parameters in the “value” column. The “bcdUSB” reports the highest version of USB the function device supports. The value is in binary coded decimal with a format of “0xJJMN” where “JJ” is the major version number, “M” is the minor version number and “N” is the sub minor version number (e.g., USB 2.0 is reported as 0x0200, USB 1.1 as 0x0110 and USB 1.0 as 0x0100). The “bDeviceClass”, “bDeviceSubClass” and “bDeviceProtocol” are used by the OS 27-2 of the second computing device 22 to find a class driver for the function devices 28-1 and/or 23-2. Typically only the “bDeviceClass” is set at the device level. Most class specifications choose to identify itself at the interface level and as a result set the “bDeviceClass” as 0x00, which allows for the one device to support multiple classes. The “bMaxPacketSize” field reports the maximum packet size for endpoint zero. All USB devices must support endpoint zero. The “idVendor” and “idProduct” are used by the operating system to find a driver for the function devices 28-1 and 23-2. The “Vendor ID” is assigned by the USB-IF. The “bcdDevice” has the same format than the bcdUSB and is used to provide a device version number. Three string descriptors may exist to provide details of the manufacturer, product and serial number. There is no requirement to have string descriptors. If no string descriptor is present, an index of zero should be used. The “bNumConfigurations” defines the number of configurations the device supports at its current speed.

In one example, the MCU 234, based on the set of codes, may generate a device descriptor for the function device 28-1 and/or 23-2 in a format shown in FIG. 3 and configures the parameters in the “Value” column of the above-mentioned table. When the device descriptor from the resource sharing device 23 is received via the second interface 24-2 and the second port 221, the second computing device 22 may recognize the function device 28-1 and/or 23-2 as a USB device attached to a USB port of the second computing device 22. For example, the storage 217 (e.g., a hard disk) of the first computing device 21 may be identified as a function device of the USB device. After receiving the device descriptor, the second computing device 22 may treat the storage 217 of the first computing device 21 as an attached hard disk and a user is capable of controlling the hard disk (e.g., reading/writing/moving/deleting data in the hard disk) by using the HIDs of the second computing device 22.

Those skilled in the art will understand that, even though only the USB descriptor format and parameters are described, the device descriptor may be generated in another descriptor format with other parameters suitable for one of the IEEE1394, Bluetooth, IrDA, Ethernet, SPI, I²C, GPIO, PCI, PCI Express port and SATA protocols.

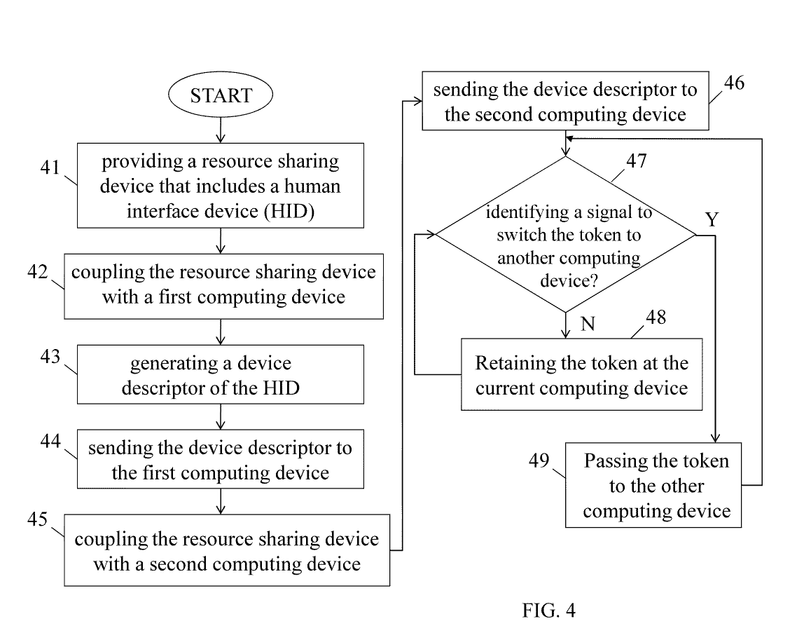

FIG. 4 is a flow diagram illustrating a method of operating a resource sharing device including a human interface device (HID) in accordance with an example of the present invention. Referring to FIG. 4, at step 41, a resource sharing device such as the one 23 described and illustrated with reference to FIGS. 2A to 2C may be provided. The resource sharing device includes a function device that further includes an HID.

At step 42, the resource sharing device may be coupled with a first computing device. An MCU of the resource sharing device may generate a device descriptor of the HID such as a mouse, keyboard or monitor at step 43.

Next, at step 44, the device descriptor may be sent to the first computing device so that the resource sharing device may serve as the HID for the first computing device.

At step 45, the resource sharing device may be coupled with a second computing device. The device descriptor may be sent to the second computing device at step 46. Since the HID function may not be used by two or more computing devices at the same time, the second computing device may not use the resource when the first computing device has the token, i.e., the authority to use the resource sharing device.

At step 47, it may be identified whether a control signal to switch the token to the second computing device is present. If not, at step 48 the first computing device with the token may continue to use the resource sharing device. If confirmative, at step 49, the second computing device takes the token and may use the resource sharing device.

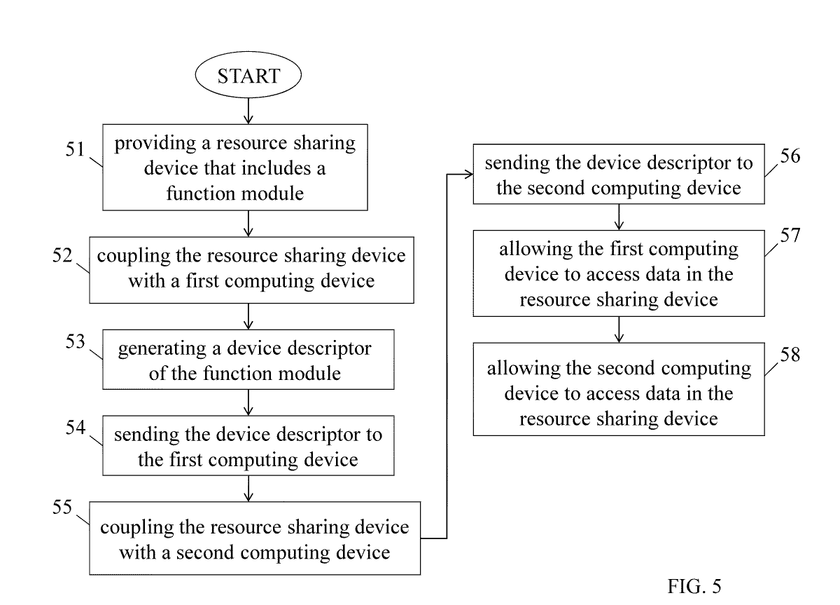

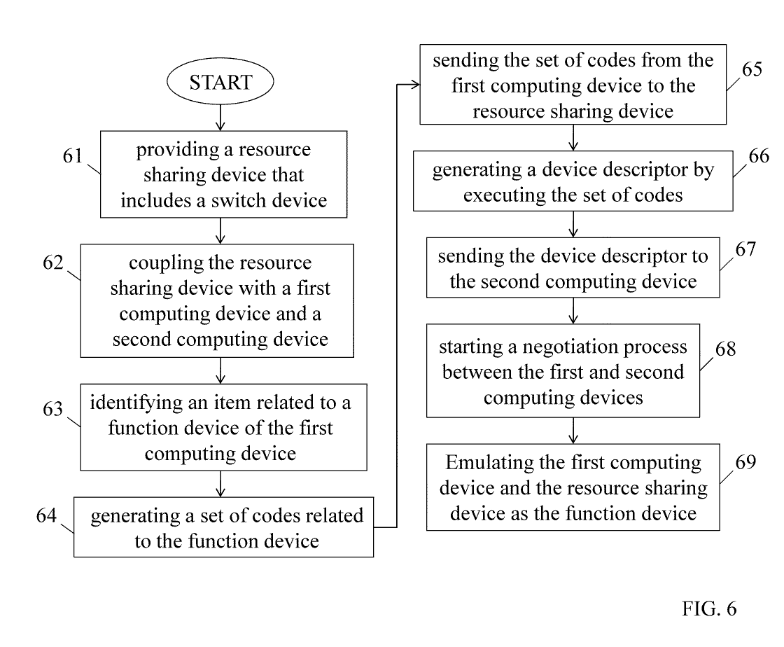

FIG. 5 is a flow diagram illustrating a method of operating a resource sharing device including a function module in accordance with an example of the present invention. Referring to FIG. 5, at step 51, a resource sharing device such as the one 23 described and illustrated with reference to FIGS. 2A to 2C may be provided. The resource sharing device includes a function device that further includes a function module.

At step 52, the resource sharing device may be coupled with a first computing device. An MCU of the resource sharing device may generate a device descriptor of the function module such as a CD-ROM, DVD-ROM or hard disk at step 53.

Next, at step 54, the device descriptor may be sent to the first computing device so that the resource sharing device may serve as the function module for the first computing device.

At step 55, the resource sharing device may be coupled with a second computing device. The device descriptor may be sent to the second computing device at step 56. Since the function module may be used by two or more computing devices at the same time, the first and second computing devices may use the resource of the function module without competing for any token.

At step 57, the first computing device may be allowed to use the resource and at step 58, the second computing device may also be allowed to use the resource of the resource sharing device.

FIG. 6 is a flow diagram illustrating a method of resource transfer from one computing device to another by using a resource sharing device in accordance with an example of the present invention. Referring to FIG. 6, at step 61, a resource sharing device such as the one 23 described and illustrated with reference to FIGS. 2A to 2C may be provided. The resource sharing device includes a switch device as well as a function device.

At step 62, the resource sharing device may be coupled with a first computing device and a second computing device. It is assumed that the first computing device has a function or resource that the second computing device may need.

At step 63, an item related to a first function device in the first computing device may be selected. A first AP module, which may be auto-run by the resource sharing device and set up in the first computing device, may generate a set of codes related to the first function device at step 64.

Next, the set of codes may be sent to resource sharing device at step 65. An MCU of the resource sharing device may generate a device descriptor of the first function device by executing the set of codes from the first computing device at step 66.

At step 67, the device descriptor may be sent to the second computing device. Subsequently, at step 68, a negotiation process between the first and second computing devices may be initiated. After negotiation, the second computing device may emulate the first computing device and the resource sharing device as whole as the first function device at step 69. That is, the second computing device may be allowed to use the resource of the first function device.

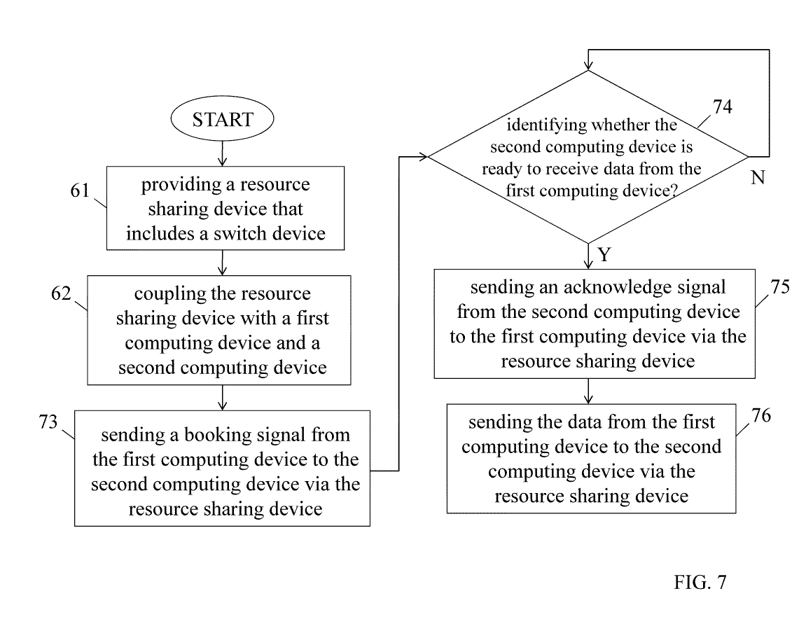

FIG. 7 is a flow diagram illustrating a method of data transfer between computing devices by using a resource sharing device in accordance with an example of the present invention. It is assumed that the first computing device has data that the second computing device may need. Referring to FIG. 7, at step 73, a booking signal may be sent from the first computing device via the resource sharing device to the second computing device.

At step 74, it may be identified whether the second computing device is ready to receive the data. If confirmative, at step 75, an acknowledge signal may be sent from the second computing device via the resource sharing device to the first computing device. In response to the acknowledge signal, the first computing may send the data via the resource sharing device to the second computing device. During data transfer, the resource sharing device may serve as a buffer between the first and second computing devices.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A resource sharing device in a communication system including multiple computing devices, the resource sharing device comprising:
a first interface to couple with a first computing device;
a second interface to couple with a second computing device;
a function device to provide a function accessible to the first and second computing devices; and
a switch device coupled with the function device, the switch device to generate a device descriptor of the function device so that when the first and second computing devices are coupled with the resource sharing device the device descriptor of the function device is sent to the first and second computing devices so as to share the function of the function device to the first and second computing devices and allow the first and second computing devices to be controllable at a time by the function of the function device.

2. The resource sharing device of claim 1, wherein the function device includes a human interface device (HID) that further includes one of a mouse, keyboard and video monitor.

3. The resource sharing device of claim 2, wherein one of the first and second computing devices is allowed to access the HID when a signal to switch a token to the one of the first and second computing devices is detected.

4. The resource sharing device of claim 1 further comprising a third interface to couple with a third computing device in the communication system, wherein the switch device is configured to send the device descriptor to the third computing device so as to share the function of the function device to the third computing device and allow the first, second and third computing devices to be controllable at a time by the function of the function device.

5. The resource sharing device of claim 1, wherein the switch device includes:
a memory to store a first set of codes associated with the function device; and
a micro processor to generate the device descriptor by executing the first set of codes.

6. The resource sharing device of claim 5, wherein the memory is configured to store a second set of codes and the micro processor is configured to generate an application module by executing the second set of codes so that the application module is set up in at least one of the first and second computing devices.

7. The resource sharing device of claim 5, wherein the micro processor is configured to generate a first device descriptor of a first function device of the first computing device and send the first device descriptor to the second computing device so that the second computing device emulates the first computing device as the first function device.

8. The resource sharing device of claim 1, wherein the switch device includes a device interface and the function device includes a device port to couple with the device interface of the switch device.

9. A resource sharing device in a communication system including multiple computing devices, the resource sharing device comprising:
a first interface to couple with a first computing device;
a second interface to couple with a second computing device;
a human interface device (HID) accessible to the first and second computing devices; and
a switch device coupled with the HID, the switch device including:
a memory to store a first set of codes associated with the HID; and
a micro processor to generate a device descriptor of the HID by executing the first set of codes,
wherein the switch device is configured to send the device descriptor of the HID to the first computing device when the first computing device is coupled with the resource sharing device, allowing the first computing device to access the HID, and send the device descriptor of the HID to the second computing device when the second computing device is coupled with the resource sharing device, allowing the second computing device to access the HID, and allowing the first and second computing devices to be controllable at a time by the HID.

10. The resource sharing device of claim 9, wherein the HID includes one of a mouse, keyboard and video monitor.

11. The resource sharing device of claim 10, wherein the HID includes the mouse, and wherein one of the first and second computing devices accesses the mouse when a coordinate margin in the other one of the first and second computing devices is detected.

12. The resource sharing device of claim 10, wherein the HID includes the video monitor, and wherein a first portion of the video monitor is configured to display a first image from the first computing device and a second portion of the video monitor is configured to display a second image from the second computing device at the same time as the first image.

13. The resource sharing device of claim 9, wherein the memory is configured to store a second set of codes and the micro processor is configured to generate an application module by executing the second set of codes so that the application module is set up in at least one of the first and second computing devices.

14. The resource sharing device of claim 9, wherein the micro processor is configured to generate a first device descriptor of a first function device of the first computing device and send the first device descriptor to the second computing device so that the second computing device emulates the first computing device as the first function device.

15. The resource sharing device of claim 9, wherein the switch device includes a device interface and the function device includes a device port to couple with the device interface of the switch device.

16. The resource sharing device of claim 9 further comprising a third interface to couple with a third computing device, wherein the switch device is configured to send the device descriptor to the third computing device so as to allow the third computing device to access the HID and allow the first, second and third computing devices to be controllable at a time by the HID.

17. A resource sharing device in a communication system including multiple computing devices, the resource sharing device comprising:
a first interface to couple with a first computing device;
a second interface to couple with a second computing device;
a function module including resources and data accessible to the first and second computing devices; and
a switch device coupled with the function device, the switch device including:
a memory to store a first set of codes associated with the function module; and
a micro processor to generate a device descriptor of the function module by executing the first set of codes,
wherein the switch device is configured to send the device descriptor of the function module to the first and second computing devices when the first and second computing devices are coupled with the resource sharing device, allowing the first and second computing devices to access the function module at the same time.

18. The resource sharing device of claim 17, wherein the function module includes one of a USB hard drive, USB CD-ROM, USB DVD-ROM, TV tuner, DVB-T tuner, printer, network interface card (NIC), embedded CD-ROM and hard disk.

19. The resource sharing device of claim 17, wherein the memory is configured to store a second set of codes and the micro processor is configured to generate an application module by executing the second set of codes so that the application module is set up in at least one of the first and second computing devices.

20. The resource sharing device of claim 17, wherein the micro processor is configured to generate a first device descriptor of a first function device of the first computing device and send the first device descriptor to the second computing device so that the second computing device emulates the first computing device as the first function device.
